(19) United States
(12) Patent Application Publication
(10) Pub. No.: US 2017/0201116 A1
(43) Pub. Date: Jul. 13, 2017

(54) WIRELESS CHARGER COUPLING FOR ELECTRONIC DEVICES

(71) Applicant: Intel Corporation, Santa Clara, CA (US)

(72) Inventors: Xiaoguo Liang, Shanghai (CN); Hong W. Wong, Portland, OR (US); Songnan Yang, San Jose, CA (US); Jiancheng Tao, Shanghai (CN); Jian Wang, Shanghai (CN)

(73) Assignee: Intel Corporation, Santa Clara, CA (US)

(21) Appl. No.: 15/323,903

(22) PCT Filed: Sep. 28, 2014
(86) PCT No.: PCT/CN2014/087666

§ 371 Date: Jan. 4, 2017

(51) Int. Cl. H02J 7/02; H02J 50/90; H02J 50/40

(52) U.S. Cl. CPC H02J 7/025; H02J 50/40; H02J 50/90

(57) ABSTRACT

In one example an electronic device comprises at least one sensor to detect a remote power source and a controller comprising logic, at least partly including hardware logic, to determine an input power parameter at a wireless charging device, generate a signal in response to the input power parameter, and forward the signal to an actuator device. Other examples may be described.

### RELATED APPLICATIONS

The present application is a national stage application under 35 U.S.C. §371 of International Application No. PCT/CN2014/087666 filed on Sep. 28, 2014. Said Application No. PCT/CN2014/087666, is hereby incorporated herein by reference in its entireties.

### BACKGROUND

The subject matter described herein relates generally to the field of electronic devices and more particularly to a wireless charger coupling for electronic devices.

Wireless charging platforms for electronic devices typically incorporate a wireless power transmitting device which may be coupled, either by inductance or by capacitance, to a wireless power receiving device in an electronic device. Strong coupling between wireless power transmitting device and the wireless power receiving device is necessary to support efficient wireless charging. Accordingly, wireless charger coupling techniques for electronic devices may find utility.

### BRIEF DESCRIPTION OF THE DRAWINGS

The detailed description is described with reference to the accompanying figures.

FIG. 1 is a schematic illustration of an electronic device which may be adapted to implement wireless charger coupling in accordance with some examples.

FIG. 2 is a high-level schematic illustration of a wireless charger adapted to implement wireless charger coupling with an electronic device in accordance with some examples.

FIG. 3 is a flowchart illustrating operations in a method to implement wireless charger coupling in accordance with some examples.

FIGS. 4A-4C are schematic illustrations of an electronic device and a wireless charger in accordance with some examples.

FIGS. 5A-5F are schematic illustrations of an electronic device and a wireless charger in accordance with some examples.

FIGS. 6-10 are schematic illustrations of electronic devices which may be adapted to implement wireless charger coupling in accordance with some examples.

### DETAILED DESCRIPTION

Described herein are exemplary systems and methods to implement wireless charger coupling in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide coupling techniques between wireless charging systems and electronic device(s). In some examples the subject matter described herein addresses these and other issues by providing an electronic device with a wireless power receiving device such as one or more inductive receiving coils or capacitive charge plates positioned proximate a surface of the electronic device to receive electrical power from a wireless charger, e.g., via an electromagnetic coupling. The electronic device further comprises at least one sensor to detect a remote power source, establish a communication connection with the remote power source, and receive at least one power output parameter from the remote power source. The electronic device also comprises a controller comprising logic, at least partly including hardware logic, to determine an input power parameter at the wireless charging device, and to determine a power transfer efficiency parameter from the input power parameter and the output power parameter.

The controller generates a signal in response to the power efficiency transfer parameter and forwards the signal to an actuator device which adjusts a relative position of the wireless power transmitting device in a charger and the receiving wireless power receiving device in the electronic device. This adjustment may be accomplished by adjusting the position of the electronic device relative to the charging device, adjusting the position of the wireless power receiving device relative to the wireless power transmitting device, or adjusting the position of the wireless power transmitting device relative to the wireless power receiving device, or combinations thereof, The controller continues to monitor the power transfer efficiency during the adjustment process and may continue to signal the actuator to adjust the relative position of the wireless power transmitting device in the charger and the wireless power receiving device in the electronic device until the power transfer efficiency reaches a threshold value. Thus, the controller enables the power transfer efficiency parameter to be used as a proxy in an alignment algorithm between wireless power transmitting device in the charger and the wireless power receiving device in the electronic device.

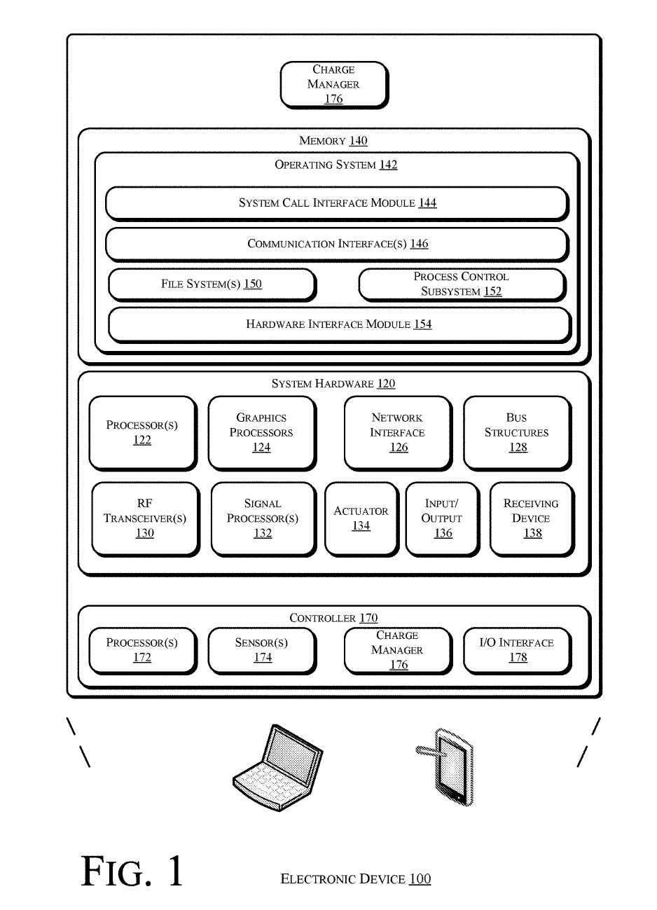

Additional features and operating characteristics of the electronic device and associated system are described below with reference to FIGS. 1-10.

FIG. 1 is a schematic illustration of an electronic device 100 which may be adapted to include a charge manager in accordance with some examples. In various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more actuators 134 and one or more input/output interfaces 136 such as, e.g., a keypad and/or a display. In some examples electronic device 100 may not have a keypad and use the touch panel for input.

Electronic device 100 may further include at least one wireless power receiving device 138 to receive power via an electromagnetic coupling with a driven coil in a charging device. The wireless power receiving device 138 may comprise one or more coil(s) to receive power through an inductive coupling with a driven coil or coupling charge plate(s) to receive power through a capacitive coupling with a driven capacitor in the charging device.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 140. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms

In the embodiment depicted in FIG. 1 the controller 170 comprises a processor 172, a sensor 174, a charge manager 176, and an I/O interface 178. In some examples sensor(s) 174 may include a wireless communication capability to detect the presence of electronic device 100. Alternatively, sensor(s) 174 may comprise one or more of an optical sensor which detects the presence of electronic device 100 or a pressure sensor to detect the positioning of electronic device 100 on charger 200. The I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples portions of the charge manager 176 may reside in the memory 140 of electronic device 100 and may be executable on one or more of the processors 122.

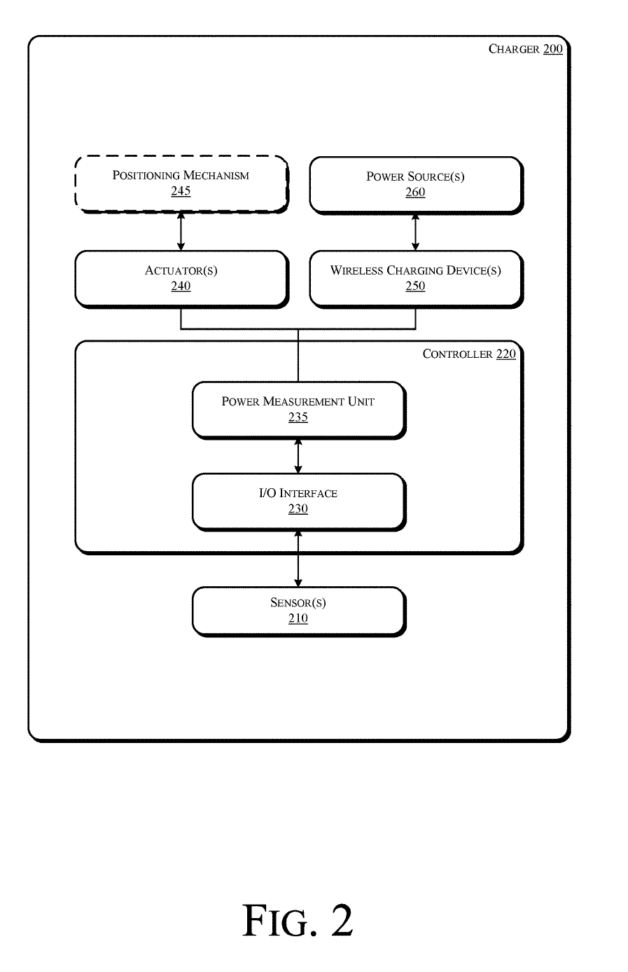

In some examples the charge manager 176 interacts with one or more other components of the electronic device 100 to manage wireless charger coupling between electronic device 100 and a wireless charging device. FIG. 2 is a high-level schematic illustration of a wireless charger adapted to implement wireless charger coupling with an electronic device in accordance with some examples. Referring to FIG. 2, charger 200 includes one or more sensors 210 to detect the presence of an electronic device such as electronic device 100 in proximity to charger 200. In some examples sensor(s) 210 may include a wireless communication capability to detect the presence of electronic device 100. Alternatively, sensor(s) 210 may comprise one or more of an optical sensor which detects the presence of electronic device 100 or a pressure sensor to detect the positioning of electronic device 100 on charger 200.

Charger 200 further comprises a controller 220, which may be embodied as general purpose processor or as a low-power controller similar to the such as controller 170 described with reference to FIG. 1. Controller 220 may comprise an input/output (I/O) interface 230, which may be implemented as a wireless communication interface as described above or a wired communication interface. Charger 200 further comprises a power measurement unit 235 . . . which may be implemented as logic instructions executable on controller 220, e.g., as software or firmware, or may be reduced to hardwired logic circuits, or combinations thereof.

Power measurement unit 235 of controller 220 may be communicatively coupled to one or more actuators 240, which in turn may be coupled to a positioning mechanism 245. Power measurement unit 235 of controller 220 may be communicatively coupled to one or more wireless charging device(s) 250, e.g., a charging coil or charging plate, which in turn may be coupled to one or more power sources 260.

In some examples the components of electronic device 100 cooperate with components of the charger 200 to facilitate wireless charger coupling between electronic device 100 and charger 200. FIG. 3 is a flowchart illustrating operations in a method to implement wireless charger coupling in accordance with some examples. Referring to FIG. 3, at operation 310 the sensor(s) 210 in the charger 200 detects the presence of an electronic device. Similarly, at operation 315 the electronic device 100 detects the presence of a charger 200.

At operation 320 the I/O interface 230 in charger 200 establishes a communication connection with the electronic device, and similarly at operation 325 the I/O interface in controller 200 establishes a communication connection with the charger. The communication connection may be established via a wireless communication interface or by a wired interface.

At operation 330 the charger 200 initiates power transmission, e.g., by coupling wireless charging device(s) 250 to power source(s) 260. In operation, the power measurement unit 235 monitors the power output of the wireless charging device, which at operation is transmitted to the electronic device 100 via the communication connection established at operation 335.

At operation 340 the electronic device receives the power output transmitted from the charger 200 at operation 335. At operation 345 the charge manager 176 in electronic device determines the power output of the wireless power receiving device 138 in electronic device 100. At operation 350 the charge manager 176 determines a power transmission efficiency parameter for power transmission between the wireless charging device(s) 250 in the charger and the wireless power receiving device 138 in electronic device 100. In one example the power transmission efficiency transmission parameter may be implemented as the ratio of the power output of wireless power receiving device 138 divided by the power output of the wireless charging device(s) 250.

If, at operation 355 the power transmission efficiency meets a minimum threshold then control passes back to operation 340. Thus, operations 340 to 355 define a loop pursuant to which the charge manager 176 continues to monitor the power transmission efficiency of charging between the wireless charging device(s) 250 in the charger and the wireless power receiving device 138 in electronic device 100.

By contrast, if at operation 355 the power transmission does not meet a minimum threshold then control passes to operation 360 and the charge manager 176 generates an actuator signal. At operation 365, the actuator signal is forwarded to one or more actuators. For example, the actuator signal may be forwarded to the actuator(s) 134 in the electronic device 100, Alternatively, or in addition, the actuator signal may be forwarded to the actuator(s) 240 in the charger 200, e.g., via the communication connection established in operations 320-325.

At operation 370 the actuator(s) receive the actuator signal transmitted by the charge manager 176 at operation 365. At operation 375 the actuator is activated in response to the signal.

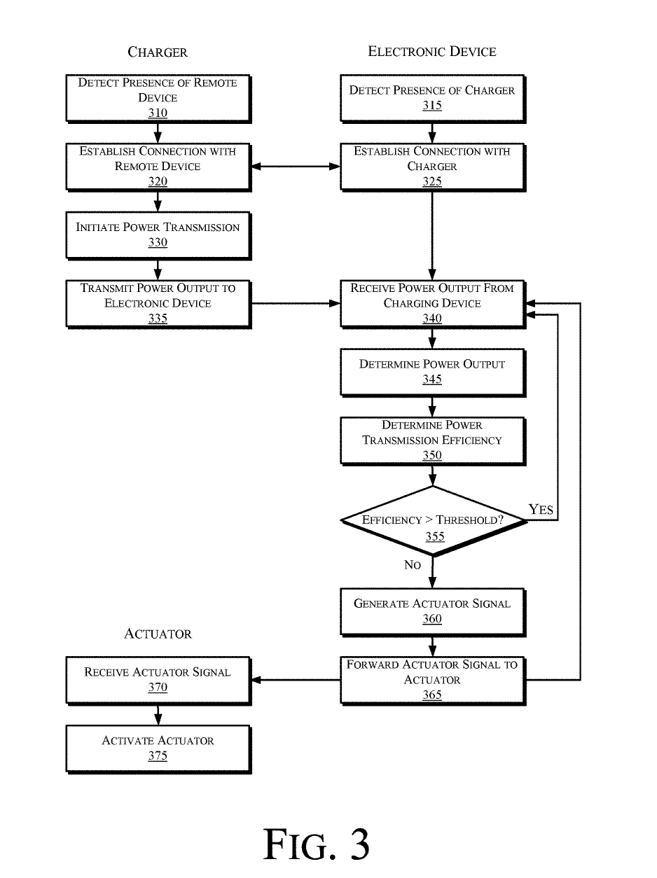

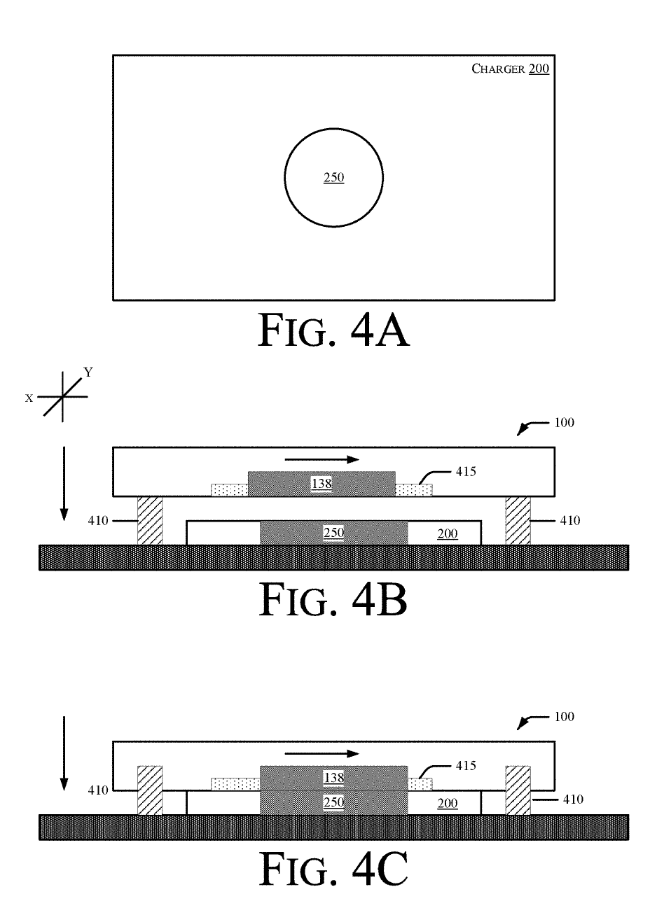

In some examples the actuator(s) adjust the relative position of the wireless charging device(s) 250 in the charger 200 and the wireless power receiving device 138 in the electronic device 100. As illustrated in FIGS. 4A-4C, in some examples actuators 134 may be coupled to one or more structural supports 410 for electronic device and the actuators 134, when activated, retract the structural supports 410 into the housing of the electronic device 100, thereby lowering the electronic device 100 onto the charger 200. Further, in some examples actuators 134 may be coupled to a platform 415 on which the wireless power receiving device 138 are mounted and the actuators 134, when activated, move the wireless power receiving device 138 in the X-Y plane to better position the wireless power receiving device 138 over the wireless charging device(s) 250.

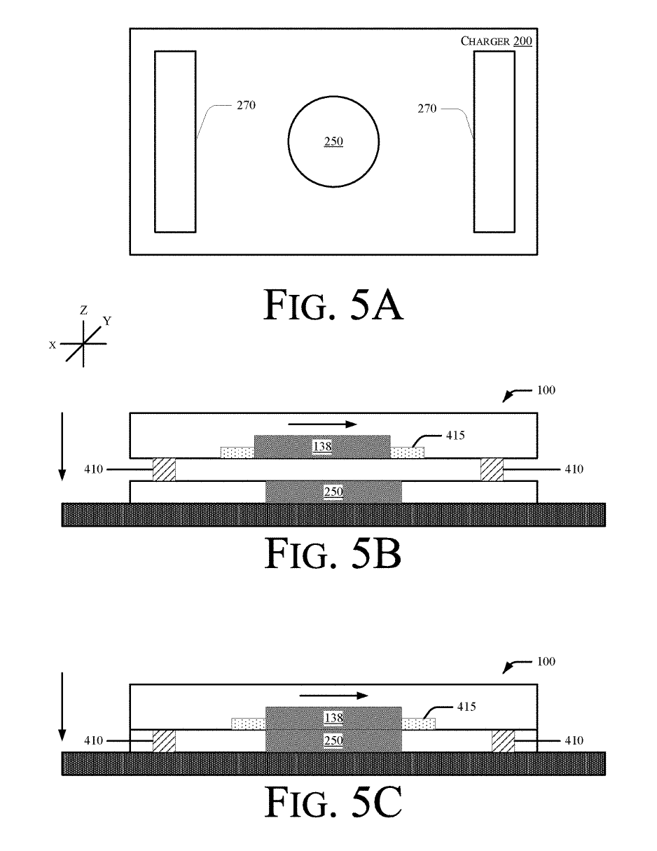

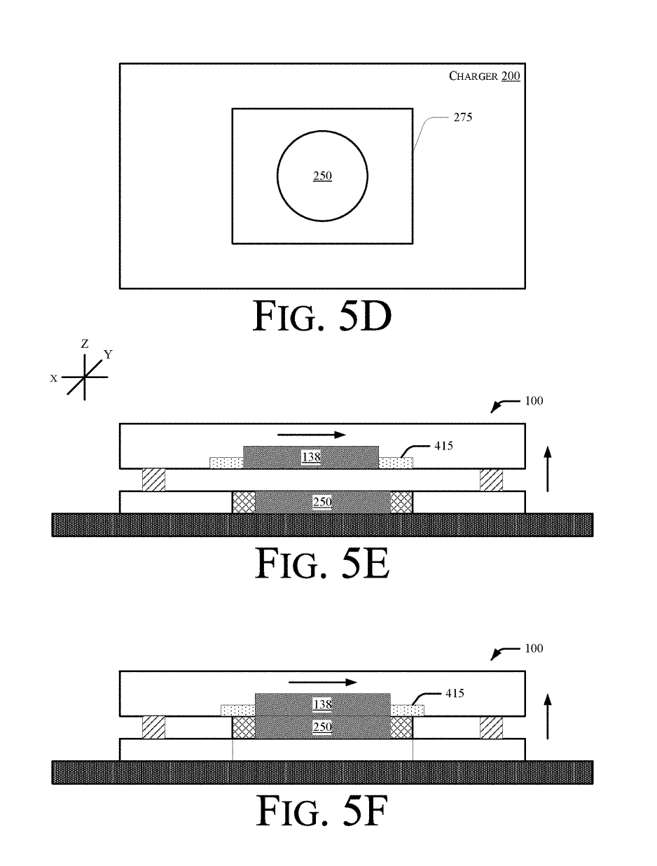

As illustrated in FIGS. 5A-5C, in some examples actuators 240 may be coupled to one or more structural supports 270 on the charger 200 and the actuators 240, when activated, retract the structural supports 270 into the housing of the charger 200, thereby lowering the electronic device 100 onto the charger 200. Further, in some examples actuators 134 may be coupled to a platform 415 on which the wireless power receiving device 138 are mounted and the actuators 134, when activated, move the receiver coil in the X-Y plane to better position the wireless power receiving device 138 over the wireless charging device(s) 250. While the example depicted in FIG. 3. illustrates steps 340-365 as being performed at the electronic device 100, one skilled in the art will recognize that these operations could be performed on the charger 200 instead on the electronic device 100. Alternatively, wireless charging device(s) 250 can also be moved in X-Y plane to better position the wireless power receiving device 138 over the wireless charging device(s) 250.

As illustrated in FIGS. 5D-5F, in some examples actuators 240 may be coupled to a platform 275 on the charger 200 and the actuators 240, when activated, raise the platform 275 from the housing of the charger 200 to bring the wireless charging device(s) 250 closer to the electronic device 100. Further, in some examples actuators 134 may be coupled to a platform 415 on which the wireless power receiving device 138 are mounted and the actuators 134, when activated, move the receiver coil in the X-Y plane to better position the wireless power receiving device 138 over the wireless charging device(s) 250. Alternatively, charging coil(s) 250 can also be moved in X-Y plane to better position the wireless power receiving device 138 over the wireless charging device(s) 250.

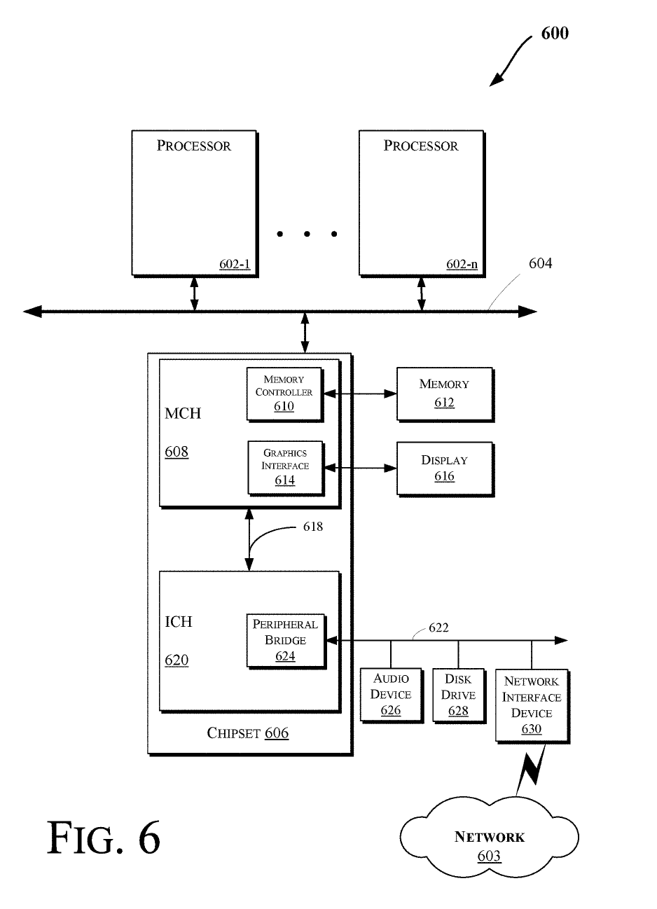

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

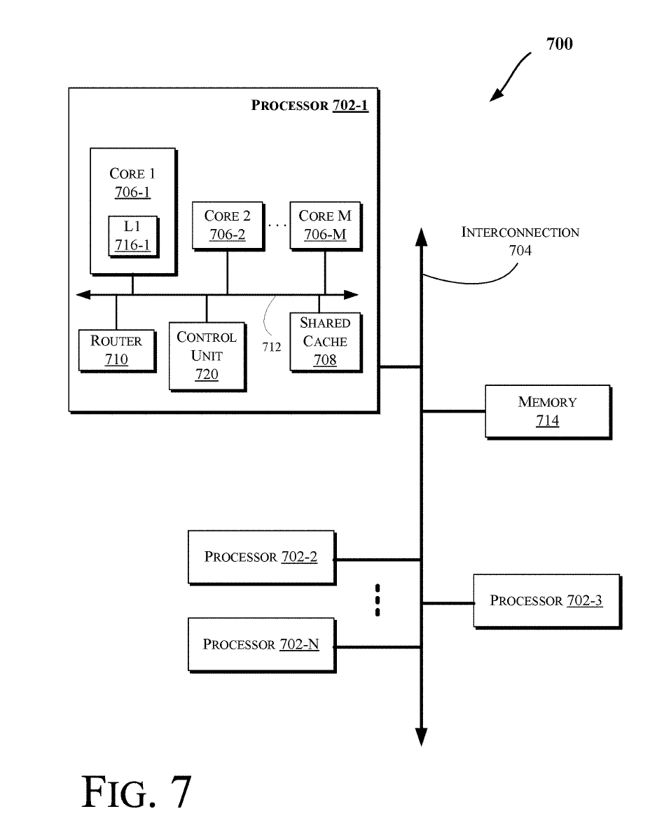

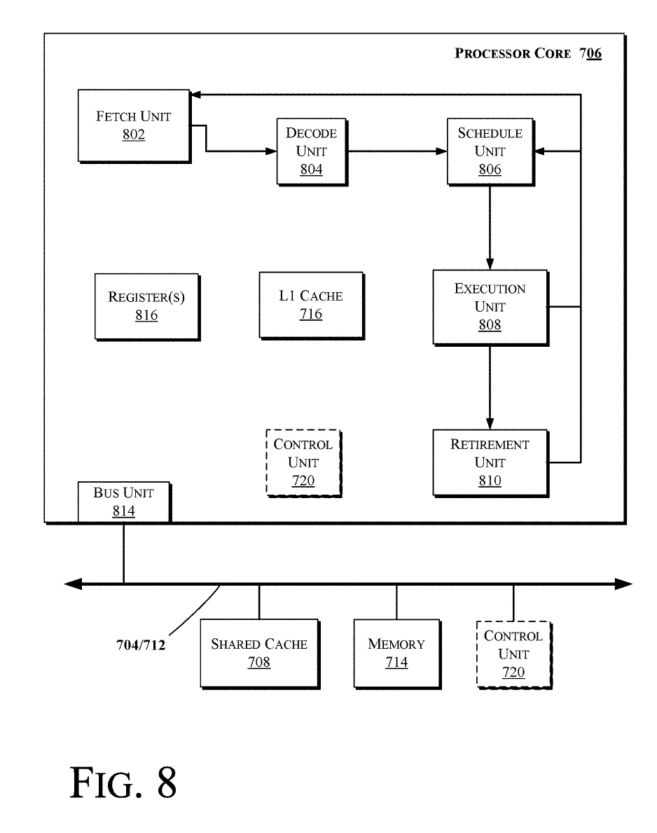

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

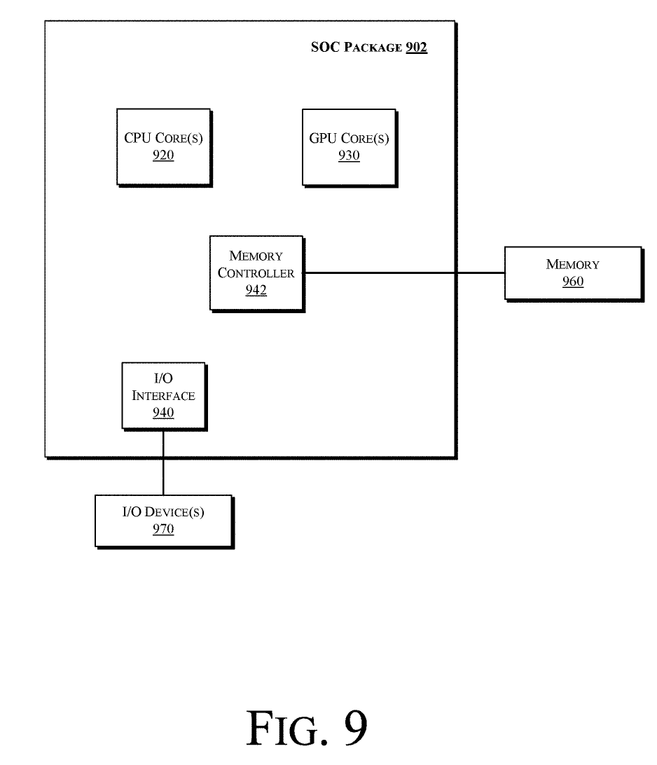

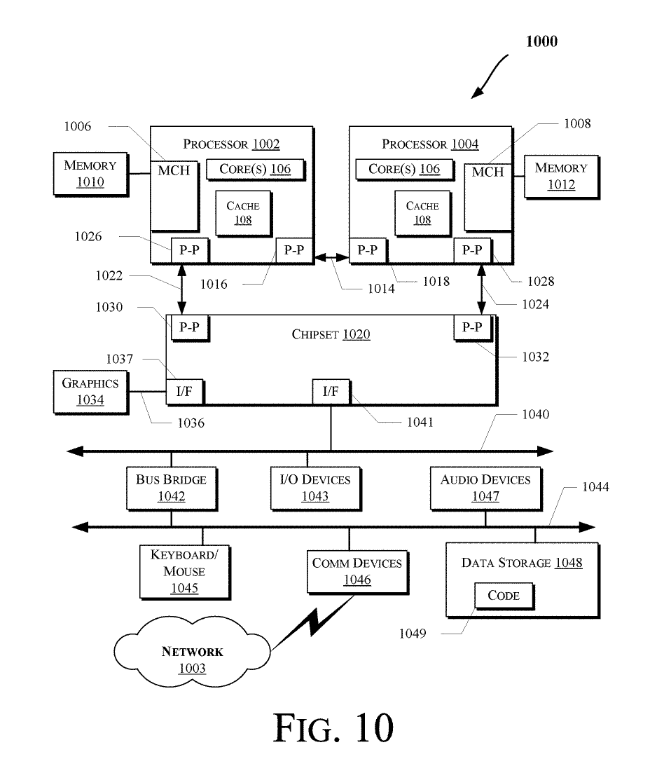

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further examples.

Example 1 is an electronic device, comprising at least one sensor to detect a remote power source and a controller comprising logic, at least partly including hardware logic, to determine an input power parameter at a wireless charging device, generate a signal in response to the input power parameter and forward the signal to an actuator device.

In Example 2, the subject matter of Example 1 can optionally include logic, at least partly including hardware logic, to establish a communication connection with the remote power source, receive at least one power output parameter from the remote power source, and forward the at least one power output parameter to the controller.

In Example 3, the subject matter of any one of Examples 1-2 can optionally include logic, at least partly including hardware logic, to determine a power transfer efficiency parameter from the input power parameter and the output power parameter, and generate a signal in response to the power efficiency transfer parameter.

In Example 4, the subject matter of any one of Examples 1-3 can optionally include at least one wireless power receiving device positioned proximate a surface of the electronic device.

In Example 5, the subject matter of any one of Examples 1-4 can optionally include an arrangement in which the wireless charging device is positioned on a platform that is moveable in at least one direction, and the actuator device moves the platform in response to the signal.

In Example 6, the subject matter of any one of Examples 1-5 can optionally include at least one support device.

In Example 7, the subject matter of any one of Examples 1-6 can optionally include an arrangement in which the actuator adjusts a height of the at least one support device in response to the signal.

Example 8 is a controller, comprising logic, at least partly including hardware logic, to determine an input power parameter at a wireless charging device, generate a signal in response to the input power parameter and forward the signal to an actuator device.

In Example 9, the subject matter of Example 8 can optionally include logic, at least partly including hardware logic, to establish a communication connection with the remote power source, receive at least one power output parameter from the remote power source, and forward the at least one power output parameter to the controller.

In Example 10, the subject matter of any one of Examples 8-9 can optionally include logic, at least partly including hardware logic, to determine a power transfer efficiency parameter from the input power parameter and the output power parameter, and generate a signal in response to the power efficiency transfer parameter.

In Example 11 the subject matter of any one of Examples 8-10 can optionally include at least one wireless power receiving device positioned proximate a surface of the electronic device.

In Example 12, the subject matter of any one of Examples 8-11 can optionally include an arrangement in which the wireless charging device is positioned on a platform that is moveable in at least one direction, and the actuator device moves the platform in response to the signal.

In Example 13, the subject matter of any one of Examples 8-12 can optionally include at least one support device.

In Example 14, the subject matter of any one of Examples 8-13 can optionally include an arrangement in which the actuator adjusts a height of the at least one support device in response to the signal.

Example 15 is a charger for an electronic device, comprising a power source, a wireless power transmitting device and a controller comprising logic, at least partly including hardware logic, to establish a communication connection with a remote electronic device, transmit at least one power output parameter to the remote electronic device source, receive a signal from the remote electronic device in response to the input power parameter and an actuator device communicatively coupled to the controller to adjust a distance between the wireless transmitting device and the remote electronic device based at least in part on the signal

In Example 16, the subject matter of Example 15 can optionally include an arrangement in which the wireless power transmitting device comprises a coil.

In Example 17, the subject matter of any one of Examples 15-16 can optionally include an arrangement in which the wireless charging device comprises at least one coil positioned proximate a surface of the electronic device.

In Example 18, the subject matter of any one of Examples 15-17 can optionally include an arrangement in which the wireless charging device is positioned on a platform that is moveable in at least one direction and the actuator device moves the platform in response to the signal.

In Example 19, the subject matter of any one of Examples 15-18 can optionally include an arrangement in which at least one support device to support the electronic device.

In Example 29, the subject matter of any one of Examples 15-19 can optionally include an arrangement in which the actuator adjusts a height of the at least one support device in response to the signal.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An electronic device, comprising:
at least one sensor to detect a remote power source; and
a controller comprising logic, at least partly including hardware logic, to:
determine an input power parameter at a wireless charging device;
generate a signal in response to the input power parameter; and
forward the signal to an actuator device.

2. The electronic device of claim 1, wherein the at least one sensor comprises logic, at least partially including hardware logic, to:
establish a communication connection with the remote power source;
receive at least one power output parameter from the remote power source; and
forward the at least one power output parameter to the controller.

3. The electronic device of claim 2, wherein the controller comprises logic, at least partly including hardware logic, to:
determine a power transfer efficiency parameter from the input power parameter and the output power parameter; and
generate a signal in response to the power efficiency transfer parameter.

4. The electronic device of claim 3, wherein the wireless charging device comprises at least one wireless power receiving device positioned proximate a surface of the electronic device.

5. The electronic device of claim 4, wherein:
the wireless charging device is positioned on a platform that is moveable in at least one direction; and
the actuator device moves the platform in response to the signal.

6. The electronic device of claim 4, further comprising:
at least one support device.

7. The electronic device of claim 6, wherein:
the actuator adjusts a height of the at least one support device in response to the signal.

8. A controller comprising logic, at least partly including hardware logic, to:
determine an input power parameter at a wireless charging device;
generate a signal in response to the input power parameter; and
forward the signal to an actuator device.

9. The controller of claim 8, further comprising logic, at least partially including hardware logic, to:
establish a communication connection with the remote power source;
receive at least one power output parameter from the remote power source; and
forward the at least one power output parameter to the controller.

10. The controller of claim 9, further comprising logic, at least partly including hardware logic, to:
determine a power transfer efficiency parameter from the input power parameter and the output power parameter; and
generate a signal in response to the power efficiency transfer parameter.

11. The controller of claim 10, wherein the wireless charging device comprises at least one wireless power receiving device positioned proximate a surface of an electronic device.

12. The controller of claim 11, wherein:
the wireless charging device is positioned on a platform that is moveable in at least one direction; and
the actuator device moves the platform in response to the signal.

13. The controller of claim 11, wherein the electronic device further comprises:
at least one support device.

14. The controller of claim 13, wherein:
the actuator adjusts a height of the at least one support device in response to the signal.

15. A charger for an electronic device, comprising:
a power source;
a wireless power transmitting device; and
a controller comprising logic, at least partly including hardware logic, to:
establish a communication connection with a remote electronic device;
transmit at least one power output parameter to the remote electronic device source;
receive a signal from the remote electronic device in response to the input power parameter; and
an actuator device communicatively coupled to the controller to adjust a distance between the wireless transmitting device and the remote electronic device based at least in part on the signal.

16. The charger of claim 15, wherein the wireless power transmitting device comprises a coil.

17. The charger of claim 15, wherein the wireless charging device comprises at least one coil positioned proximate a surface of the electronic device.

18. The charger of claim 17, wherein:
the wireless charging device is positioned on a platform that is moveable in at least one direction; and
the actuator device moves the platform in response to the signal.

19. The charger of claim 15, further comprising:
at least one support device to support the electronic device.

20. The electronic device of claim 19, wherein:
the actuator adjusts a height of the at least one support device in response to the signal.
